(19) United States
(12) Patent Application Publication
(10) Pub. No.: US 2010/0147510 A1
(43) Pub. Date: Jun. 17, 2010

(54) REMOTE LOGGING OPERATIONS ENVIRONMENT

(75) Inventors: Pan Kwok, Sugar Land, TX (US); Stanley E. Johnson, Youngsville, LA (US); Michael E. Malone, Tomball, TX (US)

Correspondence Address: SCHWEGMAN, LUNDBERG & WOESSNER, P.A., P.O. BOX 2938, MINNEAPOLIS, MN, 55402, US

(73) Assignee: Halliburton Energy Services, Inc., Houston, TX (US)

(21) Appl. No.: 12/301,853

(22) PCT Filed: May 23, 2006
(86) PCT No.: PCT/US06/19892

§ 371 Date: Jun. 4, 2009

(51) Int. Cl. E21B 47/00; G05B 15/02; E21B 47/01; E21B 7/00; G06F 3/048

(52) U.S. Cl. 166/250.01; 700/275; 166/65.1; 175/40; 166/53; 715/772; 700/90

(57) ABSTRACT

In some embodiment, apparatus [200] and systems [264], as well as methods, may operate to remotely control a well-site logging system, direct activities of well-site logging personnel, and provide electronic audio, visual, and data communication to enable communication between a remote entity [229] and the well-site logging personnel [217] using a global computer network [225]. Remote control of the well-site logging system by either the well-site logging personnel or the remote entity may also be enabled.

### TECHNICAL FIELD

Various embodiments described herein relate to petroleum recovery operations, including apparatus, systems, and methods used to record information in well bore environments.

### BACKGROUND INFORMATION

Creating a more attractive work environment for the next generation of field service personnel may serve to improve service quality, to lower the recurring cost of new field personnel development, and to improve the declining retention rates of field service technical professionals, including those in the petroleum recovery industry.

### BRIEF DESCRIPTION OF THE DRAWINGS

FIGS. 1A-1G illustrate an apparatus framework and several apparatus, respectively, according to various embodiments of the invention.

FIGS. 2A-2B illustrate apparatus and systems according to various embodiments of the invention.

FIGS. 3A-3B illustrate flow diagrams of several methods according to various embodiments of the invention.

FIG. 4 is a block diagram of an article according to various embodiments of the invention.

### DETAILED DESCRIPTION

In some embodiments of the invention, the challenges described above may be addressed by utilizing substantially real time (RT) service in a remote logging environment, which in many embodiments can operate to diversify the field personnel requirement, create a more attractive work environment for the next generation of field personnel, and improve service quality.

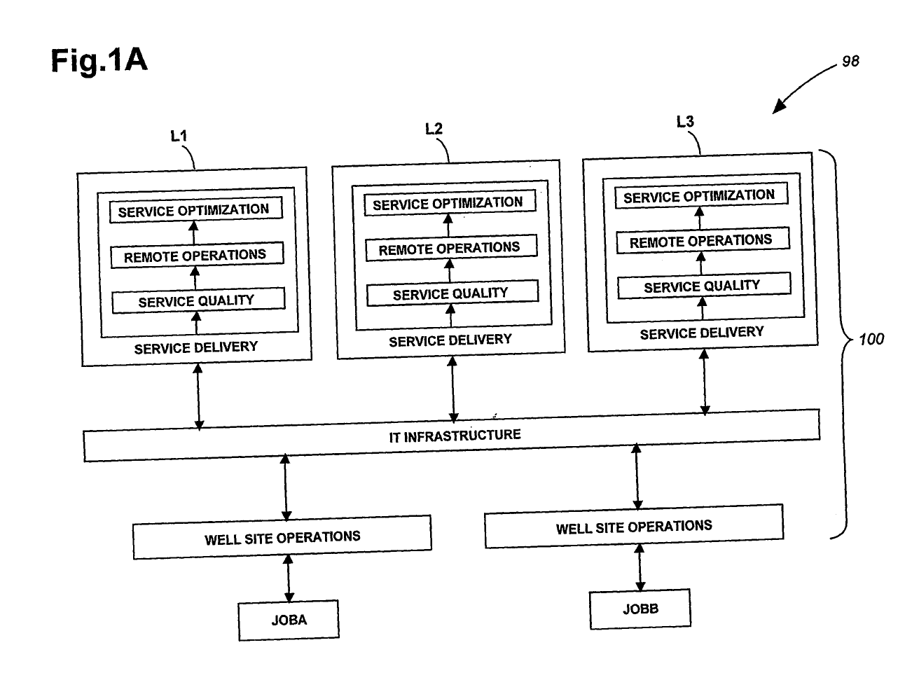

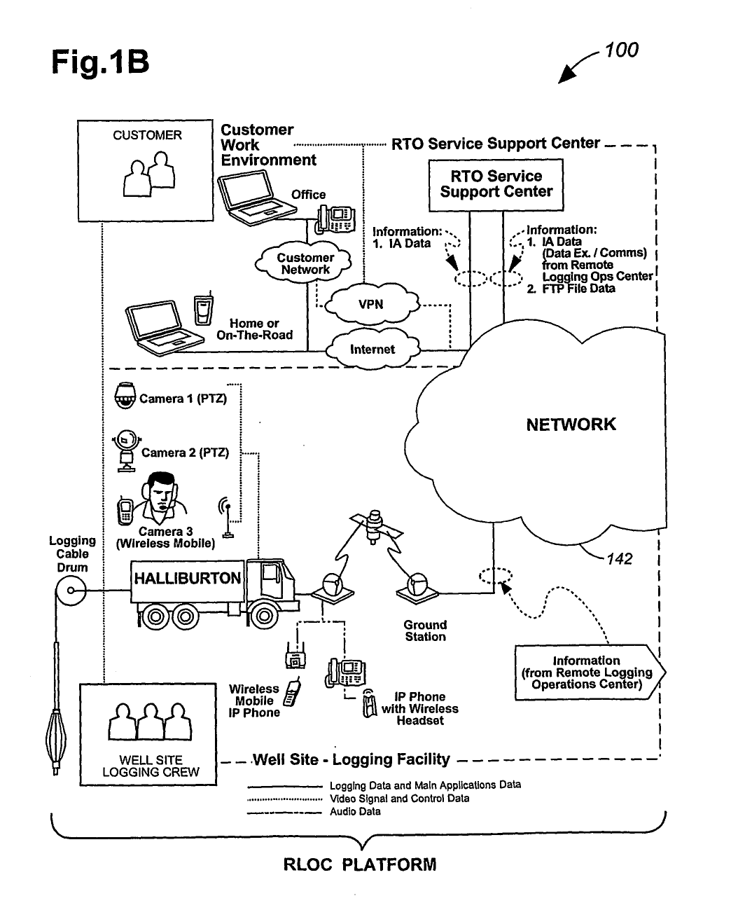

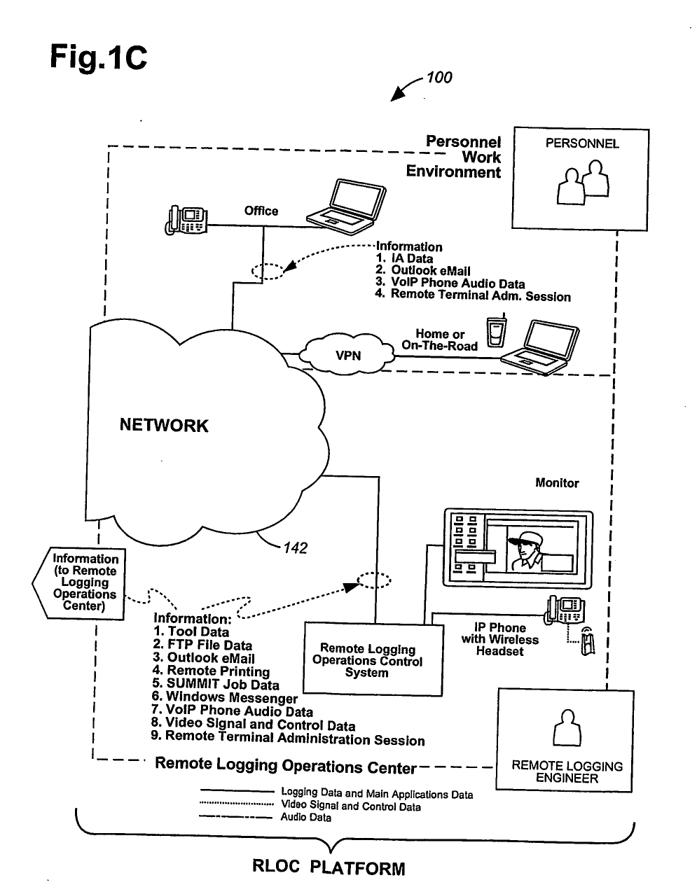

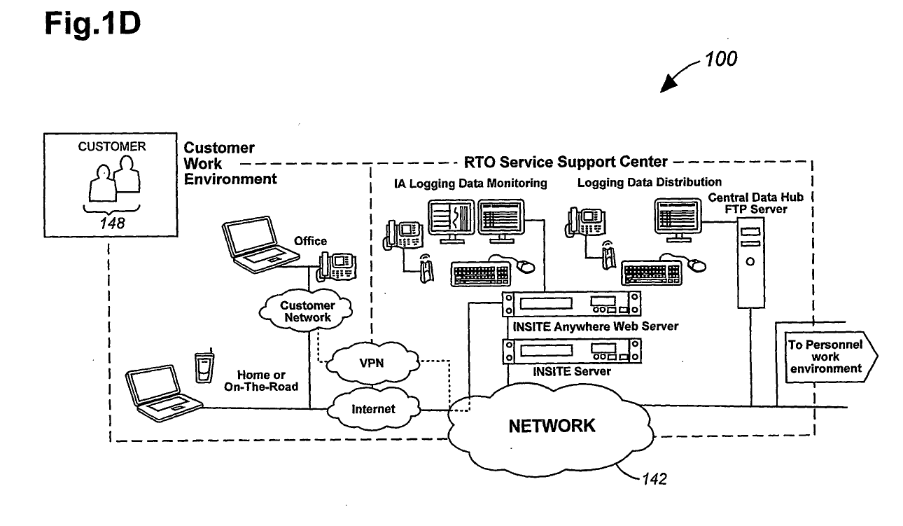

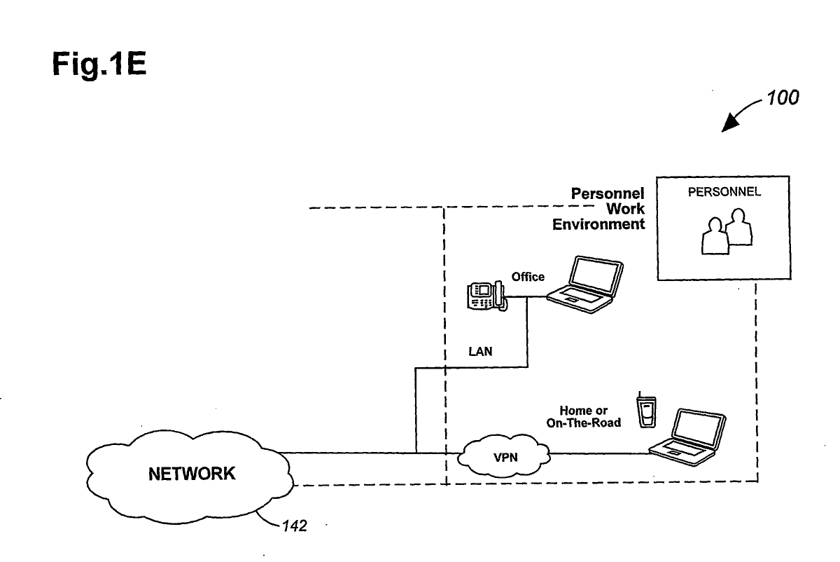

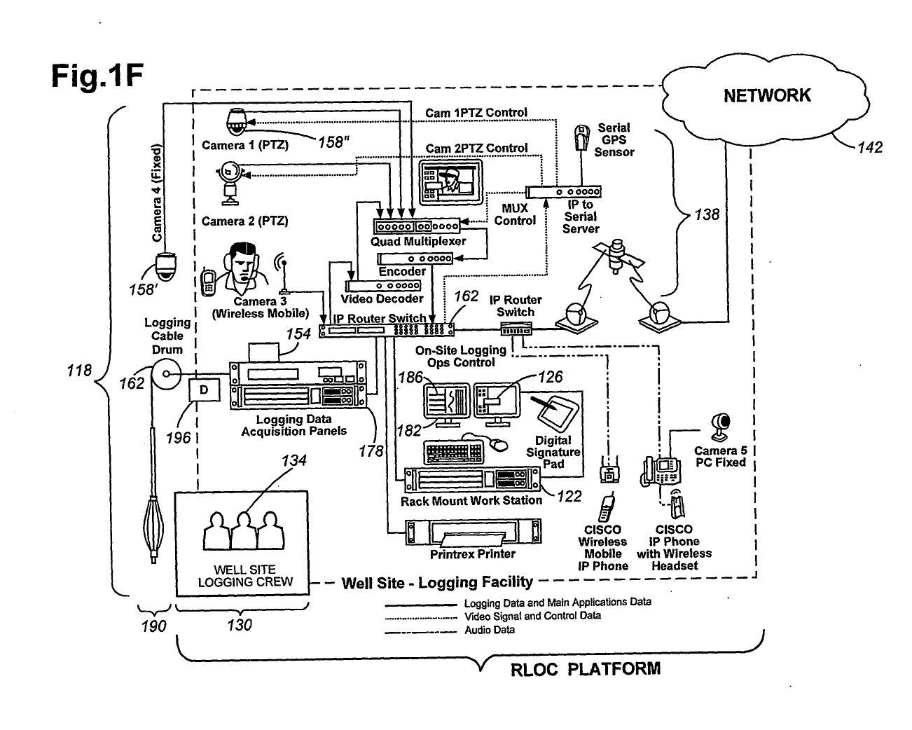

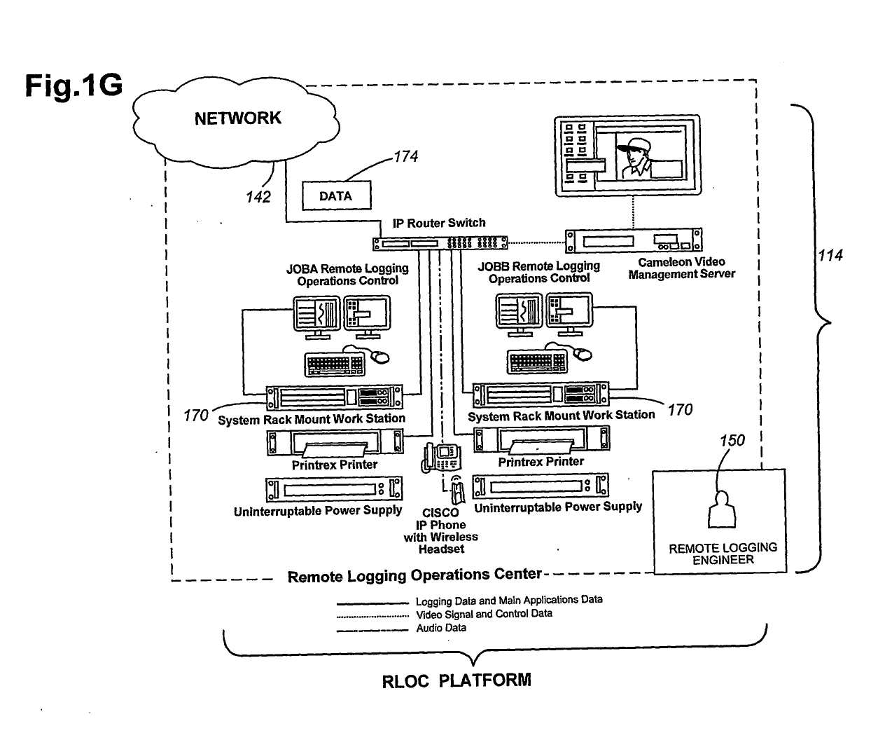

FIGS. 1A-1G illustrate an apparatus framework and several apparatus, respectively, according to various embodiments of the invention. In order to gain a better understanding of RT service, the system, the different activities, and their elements, please refer now to FIG. 1A, which shows a framework 98 of the apparatus 100, which includes well site operations (e.g., data acquisition and/or aggregation), information technology (IT) infrastructure (e.g., data communication), service delivery (e.g., data monitoring), service quality assurance and/or control (e.g., data verification and job intervention), remote operations (e.g., job remote control), and service optimization (e.g., job analysis, data interpretation, and optimization based on data interpretation).

In well-site operations, the service company can acquire data from surface and/or downhole sensors to be stored into a common well-site database. The acquired data may be displayed at the well-site to ensure the quality of data measurement and reliability of the sensors and actuators.

The IT infrastructure can be used to transmit data from the well-site to other locations (e.g., customer, remote site). Thus, data communication, data security, and data accessibility may also be provided.

For service delivery, the data may be replicated into one or more databases, both at the well-site and remotely. Plotting and rendering applications enable monitoring and presentation of the data acquired at the well-site to other locations. The IT infrastructure and system elements such as communication, databases, and servers may also be monitored to ensure the continuity of service.

Service quality assurance and/or control may involve the use of an experienced remote engineer working in concert with a well-site engineer or operator performing a particular job. The remote engineer may actively monitor the replicated data to ensure appropriate correlation between data display, data response, and the well site services being performed. The remote engineer can intervene at any time, including when the job is outside expected service quality standards. During this activity, the remote engineer can also function as a technical advisor, while the well-site engineer or operator retains control of the job.

For the purposes of this document, it should be understood that the terms “engineer” and “operator” with respect to well-site loggin personnel and remote entities are used here as those terms are commonly understood by those of skill in the art in the petroleum recovery industry. Thus, the term “engineer” does not necessarily mean one who is licensed by a state board of engineering, or its equivalent. Nor does the term “engineer” necessarily mean one who has been granted a four-year degree from an accredited engineering school.

In addition, the remote engineer, remote customers, and others that are not located at the well-site, may be collectively referred to as a “remote entity”. Similarly, the well-site engineer, operator, and other well-site personnel may be referred to collectively herein as well-site logging personnel.

Remote operations may also involve remote entities (e.g., an experienced remote engineer) and personnel at the well site (e.g., well-site logging personnel, such as a well-site engineer and/or operator). In this case, the remote engineer may retain control of the job while the well-site engineer or operator performs activities such as actuating the necessary mechanisms and controls required to deliver the service. Of course, in many embodiments, actuation may be under the direct control of the remote engineer, using remote control electronic, and electro-mechanical mechanisms, such that no well-site engineer or operator or other well-site logging personnel are needed to accomplish the work initiated by the remote engineer. In other embodiments, a mix of operations may be performed: some initiated by the remote engineer or other elements of a remote entity, and some initiated by the remote control equipment in response to acquired data. In some embodiments, no interaction or initiation by the well-site or remote engineers or operator/personnel is needed; activities are completely automated and autonomously directed by the remote control equipment.

In service optimization, data may be analyzed and interpreted, and activities may be optimized. Experts and the remote engineer may utilize specialized program applications to provide log analysis, petrophysics interpretation, and optimization of the service being delivered.

The remote operations environment may be defined by several components, including but not limited to the type of logging service, the technology and platforms used, the process and procedures used, and personnel requirements. In some embodiments, the remote operations environment couples several locations, such as locations L1, L2, and L3 in FIG. 1A, to the well site(s), including jobs JOBA and JOBB, via a single interconnected IT infrastructure.

Turning now to FIGS. 1B-1G, a more detailed view of the apparatus 100 for several embodiments can be seen. For example, a remote logging operations center (RLOC) platform may perform a variety of functions, such as enabling communication/collaboration between a remote entity, such as the remote engineer, and the well-site logging personnel. Other functions may include remote control of the logging operations by the remote engineer from an RLOC, remote monitoring of the logging operations by a variety of personnel via the network infrastructure, enabling communication/collaboration on demand between an authorized customer, the remote engineer, the well site logging personnel, and permitting remote witness of the job by an authorized customer via a public network infrastructure, such as a global communications network.

The platform may be divided into any number of elements. However, for convenience, the following division will be made: Platform P1: Network Connectivity infrastructure; Platform P2: Audio communications; Platform P3: Video communications; Platform P4: Remote Logging Operations Center; Platform P5: Logging Truck Unit; Platform P6: INSITE Anywhere; and Platform P7: Central Data Hub, Log-Space, Well-Space, and Field-Space.

Platform P1 can provide a secure network infrastructure with adequate bandwidth connectivity to enable the overall platform to function effectively and reliably. The combination of Platforms P2 and P3 can be used to enable communication/collaboration operations for well-site personnel, remote personnel, and customers. The combination of Platforms P4 and P5 can create an operations control and monitor environment for well-site and remote (control) personnel. The RLOC Platform (a combination of Platforms P1, P2, P3, P4, and P5) can be integrated with the substantially real time operations service support infrastructure (Platforms P6 and P7) to provide the remote witness environment for customers. Further functional and structural detail of the various platforms is described in the following paragraphs.

Platform P1: Network Connectivity Infrastructure—The functions and structure of the network connectivity infrastructure may include a vehicular satellite link with bandwidth to handle audio, video, and logging data transfer, including voice at 64 kb/s allocation, video at 128 kb/s allocation, and logging data and other applications at 320 kb/s allocation. A satellite unit (e.g., Link-Star) and ground station (e.g., CapRock) may provide an average bandwidth of 192 kb/s, with 512 kb/s burst bandwidth. The satellite antenna may be placed in an automatic setup mode to free up well-site logging crew for other duties, so that the antenna will deploy, adjust, and synchronize with the satellite automatically. The remote logging operations control center local infrastructure may be set up to handle video, audio and logging data bandwidth capacity simultaneously from one or more logging vehicles. Each vehicle (or other logging facility data generator) may be allocated 512 kb/s bandwidth; using a T1 line with 1,500 kb/s capacity between locations can permit this type of operation.

Instead of, or in addition to the satellite link, a wireless connection may be used. For example, an 802.16 or “WiMAX” system may be used. For more information regarding IEEE 802.16 standards, please refer to “IEEE Standard for Local and Metropolitan Area Networks—Part 16: Air Interface for Fixed Broadband Wireless Access Systems, IEEE 802.16-2001”, as well as related amendments and standards, including “Medium Access Control Modifications and Additional Physical Layer Specifications for 2-11 GHz, IEEE 802.16a-2003”.

It should also be noted that although the inventive concept may be discussed in the exemplary context of an 802.xx implementation (e.g., 802.11a, 802.11g, 802.11 HT, 802.16, etc.), the claims are not so limited. Indeed, embodiments of the present invention may well be implemented as part of any wired and/or wireless system Examples include embodiments comprising multi-carrier wireless communication channels (e.g., orthogonal frequency-division multiplexing (OFDM), discrete multi-tone modulation (DMT), etc.), such as may be used within, without limitation, a wireless personal area network (WPAN), a wireless local area network (WLAN), a wireless metropolitan are network (WMAN), a wireless wide area network (WWAN), a cellular network, a third generation (3G) network, a fourth generation (4G) network, a universal mobile telephone system (UMTS), and the like communication systems.

Platform P2: Audio Communications—The functions and structure of the audio communications platform may include enabling the remote engineer to have clear voice dialogue with the well-site engineer or operator during the job, including on the rig floor during rig up and rig down operations, perhaps with background noise reduction. This may be accomplished with voice-over-Internet protocol (VoIP) phones (e.g., CISCO 7960G model) and wireless Bluetooth headsets (e.g., Plantronics CS50 model) at the remote logging operations control center and inside the logging vehicle. In this way, the remote engineer and/or the well-site engineer or operator will be able to invite other personnel into a conference during the job, with the option to allow customer participation as well. The audio and/or video teleconference may comprise an N-to-N participation environment, with or without secure/encrypted voice communication (e.g., CISCO MeetingPlace software). A bandwidth allocation for voice communication from the site may be 64 kb/s.

Platform P3: Video communications platform—The functions and structure of the video communications platform may include a variety of cameras, including a camera that enables the remote engineer to see the logging system panel meter readings, perhaps using a logging facility ceiling-mounted camera placed in front of the logging system. All cameras may comprise analog or digital cameras with remote PTZ control capability (e.g., Sony SNC-RZ30N model).

Another camera may be used to permit the remote engineer to see field crew (well-site) personnel operations, including activity on the cat walk and rig floor, and top and bottom rig sheave wheel movement, among others. This may be accomplished by using a rear truck-mounted camera placed in front of the rig. Again, the camera can be analog or digital, with remote PTZ control capability and a movement response speed on the order of about one second per 360 degree turn (e.g., Extreme CCTV Moondance model).

In some embodiments, an additional camera may be used to enable the remote engineer to see the tool string, and tool string operations. The camera may comprise a fixed, mobile, or hand-held wireless camera, perhaps operating on the rig floor (at a distance of up to 70 meters and more from the logging facility, with local and remote zoom control capability (e.g., a Visiwear ST3100 model).

Another camera may permit the remote engineer to see rig cable drum movement so that remote winch control may be achieved and observed. The camera may comprise a fixed mounted camera facing down from the cable boom, looking toward the drum.

Another camera may be used to enable the remote engineer to see the well-site logging personnel, including the well-site engineer or operator, perhaps as the well-site engineer or operator operates the logging system. In this case, the camera may comprise a desktop camera connected to the well-site engineer or operator's personal computer, perhaps using Netmeeting, Windows Messenger, or integrated CISCO video phone software (e.g., CISCO VT Advantage software). A bandwidth allocation of about 64 kb/s may be expected.

By implementing a centralized camera control center, the remote engineer can control all cameras from the RLOC, if desired. Each camera may have one or more pre-set PTZ position settings so the remote engineer does not need to laboriously adjust the camera position to view different events or locations during execution of the job (e.g., 360 Surveillance Cameleon video distribution software). The remote engineer may control which camera signals are distributed to a variety of locations (including the RLOC) served by the IT infrastructure, perhaps by using a combination of a Whitlock video distribution system, a Pelco MX4004CD multiplexer, a Pelco NET350 decoder/encoder, a Lantronix MSS4 IP to serial converter, and a Garmin Etrex GPS receiver. Multiple logging facility video displays may be available to the remote engineer for viewing on a concurrent basis, and stored for future reference, perhaps using a separate video management server. Some of these displays may be duplicated for display to others that form part of a remote entity, such as remote customers.

The logging facility display may permit the well-site personnel to select and display camera video from any of the cameras independently from the RLOC central control console. In some embodiments, the logging facility display may be mounted on the front of the power panel for use by the well-site winch operator. The video and/or audio and/or data communications platform may thus permit the RLOC and the well-site logging facility to display individual camera video independently, as well as making a video broadcast from the RLOC available to well-site, remote, and customer personnel.

Platform P4: Remote Logging Operations Center—The functions and structure of the RLOC may include enabling the remote engineer to remotely acquire and process one or more logging jobs data concurrently in real time. Thus, the RLOC may include more than one local logging server, keyboard, and monitor (e.g., dual rack-mounted Standard Systel systems). The remote engineer can then control facility/vehicle logging system terminals remotely, as well as all applications on the vehicle logging system (e.g., using Timbuktu Pro remote terminal administration software). The RLOC may serve as a buffer for multiple personnel to monitor the facility/vehicle logging terminal and the well-site operations video display. The remote engineer may also be able to print the log to the logging facility/vehicle, perhaps using a remote print server. Thus, the RLOC may serve as central buffer for the logging data and video data, while the remote engineer controls the operations of the service job. In some embodiments, the tool data may be sent through data exchange software to the RLOC, and then distribute to other locations, including the customer. In some embodiments, the tool data may be sent via file transfer protocol (FTP) directly to the other locations under the control of the remote engineer.

Platform P5: Logging Facility Unit—The functions and structure of the logging facility/vehicle may include open and cased hole logging services. The logging facility may execute a variety of logging software, including WL-INSITE, CLASS, and Warrior. The facility may comprise a dual-drum truck with a WL-IQ logging system and a roof mount ST, self-deploying satellite unit. Electronic field tickets may be generated and transmitted to the remote location for billing the customer (e.g., using a Topaz TC912 electronic signature pad). The well-site engineer or operator may be permitted to print the log data to the RLOC.

Thus, it can be seen that a variety of apparatus, systems, and methods may be used to implement the solutions described. For example, in some embodiments, a remote logging apparatus 100 may include remote control equipment 114 to remotely control an well-site logging system 118, an well-site computer workstation 122 to couple to the remote control equipment 114, the well-site computer workstation 122 to display activities 126 of well-site logging personnel 130 including an well-site engineer or operator 134, and electronic audio, visual, and data (A/V/D) communication equipment 138 to couple to the well-site computer workstation 122 and to a global computer network 142. The electronic A/V/D communication equipment 138 may enable communication between well-site logging personnel (e.g., the well-site engineer or operators 134), and a remote entity, including remote customers 148 and remote engineers 150, as well as enabling control of the remote control equipment 114 by well-site logging personnel, including the well-site engineer or operator 134, any or all elements that comprise the remote entity, such as the remote engineer 150 and/or a remote customer 148. The remote control equipment 114 may include a remote winch control 154 to couple to the well-site logging system 118, and a camera 158′ to record cable drum 162 movement associated with operation of the remote winch control 154.

In some embodiments, the apparatus 100 may include data streaming apparatus 166 to couple to the well-site computer workstation 122, as well as a remote computer workstation 170 to receive streaming, replicated data 174 from the well-site computer workstation 122. The apparatus 100 may also include a logging system panel 178 associated with the well-site logging system 118, and a camera 158″ to record meter readings presented by the logging system panel 178. In some embodiments, the apparatus 100 may include a display 182 to display visual representations 186 of remote control operations 190 associated with the remote control equipment 114, and of data 196 acquired by the well-site logging system 118.

Many other embodiments may be realized. For example, in a well-site that is operated primarily by remote control (e.g., the well-site may even be unmanned in some embodiments), the apparatus 100 may include remote control equipment 114 to remotely control the well-site logging system 118 and a well-site computer workstation 122 to couple to the remote control equipment 114 and to display operations at the well-site. The apparatus 100 may also include electronic A/V/D communication equipment 138 to couple to the well-site computer workstation 122 and to a global computer network 142. The A/V/D communication equipment 138 may operate to enable communication between a variety of remote entities, such as a remote engineer 150 and/or a remote customer 148. The A/V/D communication equipment 138 may also enable control of the remote control equipment 114 by any of the remote entities, such as the remote engineer 150 and the remote customer 148.

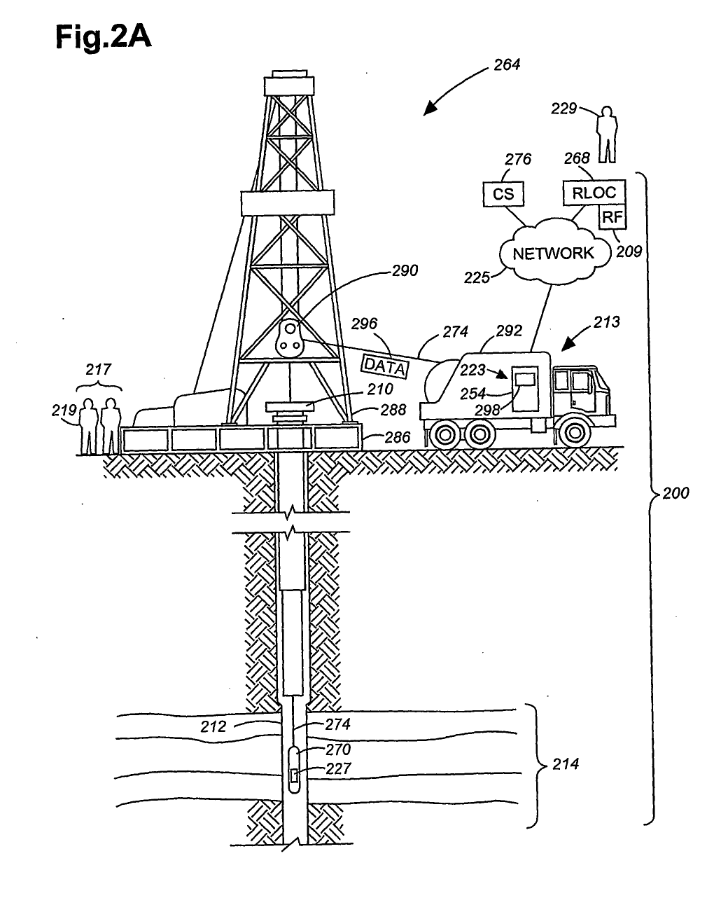

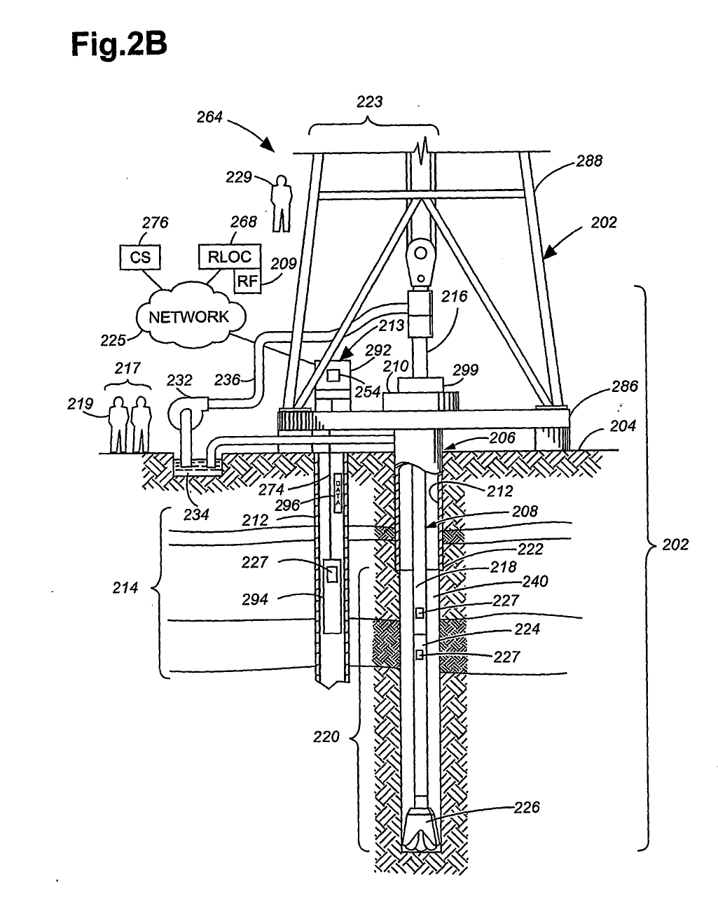

FIGS. 2A-2B illustrate apparatus 200 and systems 264 according to various embodiments of the invention. The apparatus 200, which may be similar to or identical to the apparatus 100 described above and shown in FIG. 1, may comprise portions of a logging facility 292, an RLOC 268, a customer site 276, and a tool body 270 as part of a wireline logging operation, or of a downhole tool 224 as part of a downhole drilling operation. For example, FIG. 2A shows a well during wireline logging operations. A drilling platform 286 may be equipped with a derrick 288 that supports a hoist 290. Drilling oil and gas wells is commonly carried out using a string of drill pipes connected together so as to form a drilling string that is lowered through a rotary table 210 into a wellbore or borehole 212.

In FIG. 2A it is assumed that the drilling string has been temporarily removed from the borehole 212 to allow a tool body 270 (e.g., a wireline logging tool), such as a probe or sonde, to be lowered by wireline or logging cable 274 into the borehole 212. Typically, the tool body 270 is lowered to the bottom of the region of interest and subsequently pulled upward at a substantially constant speed. During the upward trip, instruments included in the tool body 270 (e.g., apparatus 200) may be used to perform measurements on the subsurface formations 214 adjacent the borehole 212 as they pass by. The measurement data 296, including logging data, can be communicated to a logging facility 292 for storage, processing, and analysis. The logging facility (perhaps comprising a logging vehicle) 292 may be provided with electronic equipment for various types of signal processing. Similar logging data 296 may be gathered and analyzed during drilling operations (e.g., during LWD operations). For example, the tool body 270 in this case may house portions of one or more apparatus 200, and the logging facility 292 may include one or more surface computers 254.

Turning now to FIG. 2B, it can be seen how a system 264 may also form a portion of a drilling rig 202 located at a surface 204 of a well 206. The drilling rig 202 may provide support for a drill string 208. The drill string 208 may operate to penetrate a rotary table 210 for drilling a borehole 212 through subsurface formations 214. The drill string 208 may include a Kelly 216, drill pipe 218, and a bottom hole assembly 220, perhaps located at the lower portion of the drill pipe 218. The drill string 208 may include wired and unwired drill pipe, as well as wired and unwired coiled tubing.

The bottom hole assembly 220 may include drill collars 222, a downhole tool 224, and a drill bit 226. The drill bit 226 may operate to create a borehole 212 by penetrating the surface 204 and subsurface formations 214. The downhole tool 224 may comprise any of a number of different types of tools including MWD tools, LWD tools, and others.

During drilling operations, the drill string 208 (perhaps including the Kelly 216, the drill pipe 218, and the bottom hole assembly 220) may be rotated by the rotary table 210. In addition to, or alternatively, the bottom hole assembly 220 may also be rotated by a motor (e.g., a mud motor) that is located downhole. The drill collars 222 may be used to add weight to the drill bit 226. The drill collars 222 also may stiffen the bottom hole assembly 220 to allow the bottom hole assembly 220 to transfer the added weight to the drill bit 226, and in turn, assist the drill bit 226 in penetrating the surface 204 and subsurface formations 214.

During drilling operations, a mud pump 232 may pump drilling fluid (sometimes known by those of skill in the art as “drilling mud”) from a mud pit 234 through a hose 236 into the drill pipe 218 and down to the drill bit 226. The drilling fluid can flow out from the drill bit 226 and be returned to the surface 204 through an annular area 240 between the drill pipe 218 and the sides of the borehole 212. The drilling fluid may then be returned to the mud pit 234, where such fluid is filtered. In some embodiments, the drilling fluid can be used to cool the drill bit 226, as well as to provide lubrication for the drill bit 226 during drilling operations. Additionally, the drilling fluid may be used to remove subsurface formation 214 cuttings created by operating the drill bit 226.

Thus, referring now to FIGS. 1A-1G and 2A-2B, it may be seen that in some embodiments, the system 264 may include a drill collar 222, and a downhole tool 224, including a tool body 270 or a substantially permanently installed probe 294 (in a downhole well), to which one or more apparatus 200 are coupled. The downhole tool 224 may comprise an LWD tool or MWD tool. The tool body 270 may comprise a wireline logging tool, including a probe or sonde, for example, coupled to a cable 274, such as a wireline or logging cable. Thus, a wireline 274 or a drill string 208 may be mechanically coupled to the downhole tool 224.

Many embodiments may be realized. For example, in some embodiments then, a system 264, such as a remote controlled logging system, may include a downhole tool 224, remote control equipment 209 to remotely control an well-site logging system 213 and the downhole tool 224, an well-site computer workstation 254 to couple to the remote control equipment 209, and to display activities of well-site logging personnel 217 including a well-site engineer 219, and electronic A/V/D communication equipment 223 to couple to the well-site computer workstation 254 and to a global computer network 225, as described above.

In some embodiments, the downhole tool 224 may include formation pressure, temperature, resistivity, acoustic, nuclear, natural radiation, downhole wellbore camera, resistivity imaging, acoustic imaging, and/or magnetic resonance imaging equipment 227. A wireline 274 may be coupled to the downhole tool 224.

In some embodiments, the system 264 may include a drill bit 226 mechanically coupled to a drill string 208 and the downhole tool 224, as well as a steering mechanism 299 to steer the drill bit 226 responsive to commands initiated by the remote control equipment 209. Such commands may be automatically initiated, or initiated at the behest of the the well-site engineer 219, and/or the remote entity, to include a remote engineer 229. The drill string 208 may include segmented drilling pipe, casing, and/or coiled tubing. In some embodiments, the system 264 may include one or more displays 298 to display a variety of data, as described above. The display 298 may be included as part of a surface computer 254 used to receive data 296 from the downhole tool 224, if desired.

The apparatus 100, 200; remote control equipment 114, 209; well-site logging system 118, 213; computers 122, 254; activities 126; well-site logging personnel 130, 217; well-site engineer 134, 219; A/V/D communication equipment 138, 223; global computer network 142, 225; remote customers 148; remote engineers 150, 229; winch control 154; cameras 158′, 158″; cable drum 162; data streaming apparatus 166; remote computer workstation 170; replicated data 174; logging system panel 178; displays 182, 298; visual representations 186; remote control operations 190; data 196, 296; drilling rig 202; surface 204; well 206; drill string 208; rotary table 210; borehole 212; formations 214; Kelly 216; drill pipe 218; bottom hole assembly 220; drill collars 222; downhole tool 224; drill bit 226; formation pressure, temperature, resistivity, acoustic, resistivity, nuclear, natural radiation, downhole wellbore camera, resistivity imaging, acoustic imaging, and magnetic resonance imaging equipment 227; mud pump 232; mud pit 234; hose 236; annular area 240; systems 264; RLOC 268; tool body 270; cable 274; customer site 276; drilling platform 286; derrick 288; hoist 290; logging facility 292; probe 294; data 296; displays 298; and steering mechanism 299 may all be characterized as “modules” herein.

Such modules may include hardware circuitry, and/or a processor and/or memory circuits, software program modules and objects, and/or firmware, and combinations thereof, as desired by the architect of the apparatus 100, 200 and systems 264, and as appropriate for particular implementations of various embodiments. For example, in some embodiments, such modules may be included in an apparatus and/or system operation simulation package, such as a software electrical signal simulation package, a power usage and distribution simulation package, a power/heat dissipation simulation package, and/or a combination of software and hardware used to simulate the operation of various potential embodiments.

It should also be understood that the apparatus and systems of various embodiments can be used in applications other than for drilling and logging operations, and thus, various embodiments are not to be so limited. The illustrations of apparatus 100, 200 and systems 264 are intended to provide a general understanding of the structure of various embodiments, and they are not intended to serve as a complete description of all the elements and features of apparatus and systems that might make use of the structures described herein.

Applications that may include the novel apparatus and systems of various embodiments include electronic circuitry used in high-speed computers, communication and signal processing circuitry, modems, processor modules, embedded processors, data switches, and application-specific modules, including multilayer, multi-chip modules. Such apparatus and systems may further be included as sub-components within a variety of electronic systems, such as process measurement instruments, personal computers, workstations, medical devices, vehicles, among others. Some embodiments include a number of methods.

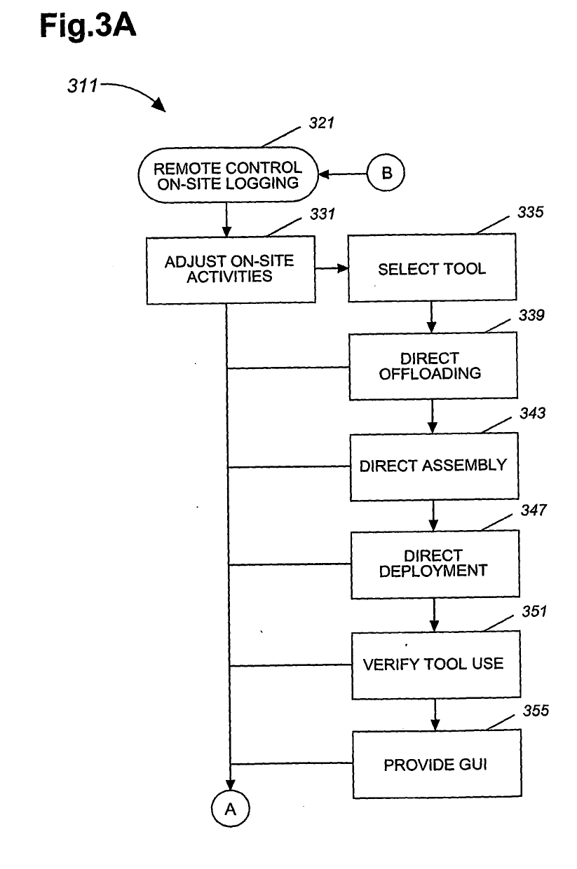

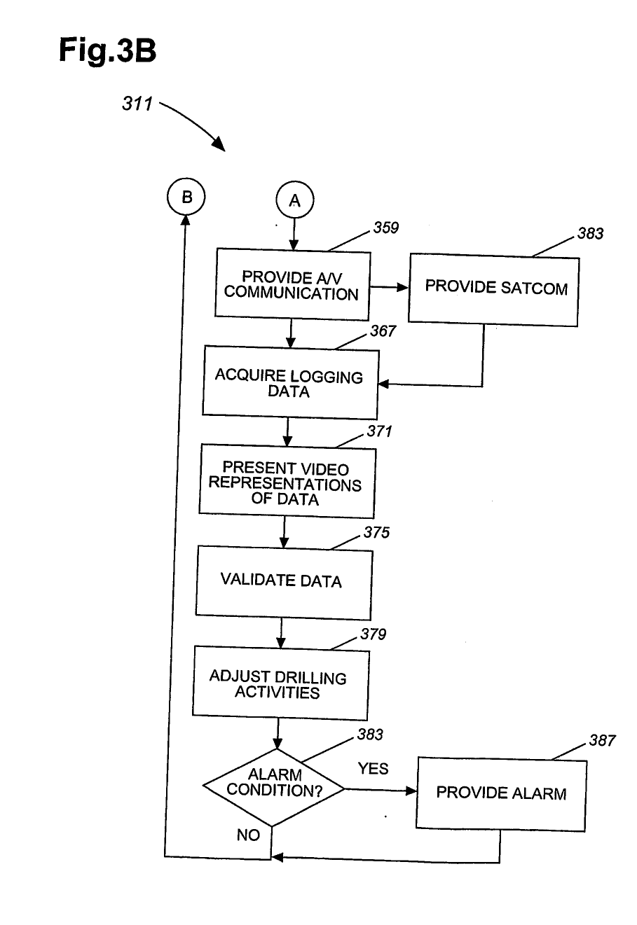

For example, FIGS. 3A-3B illustrate flow diagrams of several methods 311 according to various embodiments of the invention. In some embodiments of the invention, a method 311, such as a method of remote control logging, may begin at block 321 with remotely controlling an well-site logging system, and then continue at block 331 with directing activities of well-site logging personnel including a well-site engineer or operator. Many elements and activities may be controlled remotely, including, but not limited to, any number of the following: power application to downhole sensors, actuation of motor-driven downhole components, winch actuation, logging speed adjustment, data sampling rate adjustment, and selecting data presentation formats. As noted above, remote control may be effected by any of the elements comprising a remote entity, such as a remote engineer and/or a remote customer.

In some embodiments, the method 311 may include choosing or selecting one or more logging tools for use at block 335. The method 311 may then go on to include directing the offloading the logging tools at block 339, directing the assembly of the logging tools at block 343, and directing deployment of the logging tools into a well at block 347.

In some embodiments, the method 311 may include verifying use of one or more logging tools at block 351. In this case, verifying may include checking (e.g., via software data or hardware signals) to be sure the tool actually used is the one that was chosen or selected at block 335. The method 311 may also include providing a graphical user interface to various elements of a remote entity, such as one or more remote customers, that duplicates a portion of an interface presented to the remote engineer at block 355.

In some embodiments, the method 311 may include, at block 359, providing electronic audio, visual, and data (A/V/D) communication to enable communication between the well-site engineer or operator, and a remote entity, including a remote engineer and one or more remote customers, using a global computer network. Providing the electronic A/V/D communication may also enable remote control of the well-site logging system by either the well-site logging personnel, (e.g., well-site engineer or operator) and/or a remote entity, such as the remote engineer and/or remote customers. The method 311 may go on to include providing electronic A/V/D communication via satellite and/or a wireless connection at block 363.

The method 311 may include, in some embodiments, acquiring logging data via the well-site logging system at block 367, and presenting video representations of the data to a remote entity, including the remote engineer and/or remote customers from one or more well logging jobs at block 371. At least some of the data presented may be acquired by the well-site logging system. The method 311 may also include concurrently validating data generated by the well-site logging system by two or more of the well-site engineer or operator, the remote engineer, and another witness (e.g., remote customers) at block 375. In this instance, the data may be validated at substantially the same time by the well-site engineer, the remote engineer, and a remote customer, for example.

In some embodiments, the method 311 may include adjusting conduct of one or more drilling operation activities based on the logging data in substantially real time at block 379. If an alarm condition is detected at block 383 (e.g., a wireline break, a drill bit fracture, a runaway cable drum, etc.), then the method 311 may include providing an alarm to the well-site logging personnel, such as a well-site engineer or operator, and/or a remote entity, such as a remote engineer and/or remote customers at block 387.

It should be noted that the methods described herein do not have to be executed in the order described, or in any particular order. Moreover, various activities described with respect to the methods identified herein can be executed in iterative, serial, or parallel fashion. Information, including parameters, commands, operands, and other data, can be sent and received, and perhaps stored using a variety of media, tangible and intangible, including one or more carrier waves.

Upon reading and comprehending the content of this disclosure, one of ordinary skill in the art will understand the manner in which a software program can be launched from a computer-readable medium in a computer-based system to execute the functions defined in the software program. One of ordinary skill in the art will further understand that various programming languages may be employed to create one or more software programs designed to implement and perform the methods disclosed herein. The programs may be structured in an object-orientated format using an object-oriented language such as Java or C++. Alternatively, the programs can be structured in a procedure-orientated format using a procedural language, such as assembly or C. The software components may communicate using any of a number of mechanisms well known to those skilled in the art, such as application program interfaces or interprocess communication techniques, including remote procedure calls. The teachings of various embodiments are not limited to any particular programming language or environment. Thus, other embodiments may be realized.

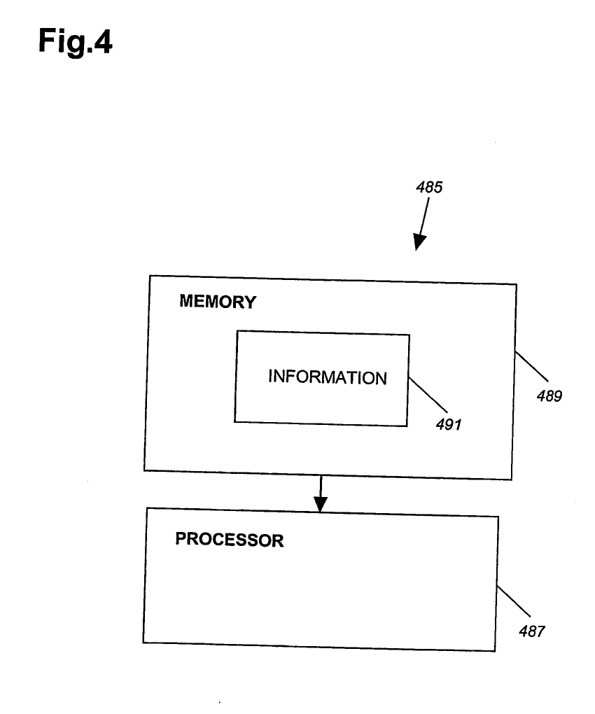

FIG. 4 is a block diagram of an article of manufacture, or article 485 according to various embodiments, such as a computer, a memory system, a magnetic or optical disk, some other storage device, and/or any type of electronic device or system. The article 485 may include a processor 487 coupled to a computer-readable medium such as a memory 489 (e.g., fixed and removable storage media, including tangible memory having electrical, optical, or electromagnetic conductors; or even intangible memory, such as a carrier wave) having associated information 491 (e.g., computer program instructions and/or data), which when executed by a computer, causes the computer (e.g., the processor 487) to perform a method including such actions as remotely controlling an well-site logging system, directing activities of well-site logging personnel including an well-site engineer or operator, and providing electronic audio, visual, and data communication to enable communication between well-site logging personnel (e.g., the well-site engineer or operator), and one or more remote entities (e.g., a remote engineer and/or remote customers) using a global computer network, and to enable remote control of the well-site logging system by either the well-site logging personnel and/or elements of the remote entity.

Further actions may include acquiring logging data via the well-site logging system, and adjusting conduct of a drilling operation activity based on the logging data in substantially real time. Additional actions may include presenting video representations of data to elements of the remote entity (e.g., the remote engineer) from one or more well logging jobs, wherein some of the data is acquired by the well-site logging system, and providing an alarm to the same elements (e.g., the remote engineer), or other elements of the remote entity (e.g., a remote customer), as well as the well-site engineer, as desired.

Implementing the apparatus, systems, and methods of various embodiments may improve field operations personnel attrition rate and operations capability, perhaps lowering the cost of new personnel development. Other potential benefits may include decreasing new field engineer or operator post-school training time-to-first ticket, and improving field service quality.

The accompanying drawings that form a part hereof, show by way of illustration, and not of limitation, specific embodiments in which the subject matter may be practiced. The embodiments illustrated are described in sufficient detail to enable those skilled in the art to practice the teachings disclosed herein. Other embodiments may be utilized and derived therefrom, such that structural and logical substitutions and changes may be made without departing from the scope of this disclosure. This Detailed Description, therefore, is not to be taken in a limiting sense, and the scope of various embodiments is defined only by the appended claims, along with the full range of equivalents to which such claims are entitled.

Such embodiments of the inventive subject matter may be referred to herein, individually and/or collectively, by the term “invention” merely for convenience and without intending to voluntarily limit the scope of this application to any single invention or inventive concept if more than one is in fact disclosed. Thus, although specific embodiments have been illustrated and described herein, it should be appreciated that any arrangement calculated to achieve the same purpose may be substituted for the specific embodiments shown. This disclosure is intended to cover any and all adaptations or variations of various embodiments. Combinations of the above embodiments, and other embodiments not specifically described herein, will be apparent to those of skill in the art upon reviewing the above description.

The Abstract of the Disclosure is provided to comply with 37 C.F.R. §1.72(b), requiring an abstract that will allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separate embodiment.

1-31. (canceled)

32. An apparatus, including:
remote control equipment to remotely control a well-site logging system;
a well-site computer workstation to couple to the remote control equipment, the well-site computer workstation to display activities of well-site logging personnel; and
electronic audio, visual, and data communication equipment to couple to the well-site computer workstation and to a global computer network to enable communication between the well-site logging personnel and a remote entity, and to enable control of the remote control equipment by either the well-site logging personnel or the remote entity.

33. The apparatus of claim 32, wherein display activities of the well-site logging personnel comprise the display activities of at least one of a well-site engineer and an operator.

34. The apparatus of claim 32, wherein the communication between the well-site logging personnel and the remote entity includes communication between the well-site logging personnel and at least one of a remote engineer and a remote customer.

35. The apparatus of claim 32, further including:
a data streaming apparatus to couple to the well-site computer workstation.

36. The apparatus of claim 32, further including:
a remote computer workstation to receive streaming, replicated data from the well-site computer workstation.

37. The apparatus of claim 32, wherein the remote control equipment includes:
a camera to record cable drum movement associated with operation of a remote winch control.

38. The apparatus of claim 32, further including:
a logging system panel associated with the well-site logging system; and
a camera to record meter readings presented by the logging system panel.

39. The apparatus of claim 32, further including:
a display to display visual representations of remote control operations associated with the remote control equipment, and of data acquired by the well-site logging system.

40. A system, including:
a downhole tool;
remote control equipment to remotely control a well-site logging system and the downhole tool;
a well-site computer workstation to couple to the remote control equipment, the well-site computer workstation to display activities of well-site logging personnel; and
electronic audio, visual, and data communication equipment to couple to the well-site computer workstation and to a global computer network to enable communication between the well-site logging personnel and a remote entity, and to enable control of the remote control equipment by either the well-site logging personnel or the remote entity.

41. The system of claim 40, wherein the well-site logging personnel comprises at least one of a well-site engineer and an operator.

42. The system of claim 40, wherein the remote entity comprises at least one of a remote engineer and a remote customer.

43. The system of claim 40, wherein the downhole tool includes:
at least one of formation pressure, temperature, resistivity, acoustic, nuclear, natural radiation, downhole wellbore camera, resistivity imaging, acoustic imaging, and magnetic resonance imaging equipment.

44. The system of claim 40, further including:
surface pressure control equipment to couple to the remote control equipment.

45. The system of claim 40, further including:
a wireline coupled to the downhole tool.

46. The system of claim 40, further including:
a drill bit mechanically coupled to a drill string and the downhole tool; and
a steering mechanism to steer the drill bit responsive to the remote control equipment.

47. The system of claim 46, wherein the drill string includes at least one of segmented drilling pipe, casing, and coiled tubing.

48. A method, including:
remotely controlling a well-site logging system;
directing activities of well-site logging personnel; and
providing electronic audio, visual, and data communication to enable communication between a remote entity and the well-site logging personnel using a global computer network, and to enable remote control of the well-site logging system by either the well-site logging personnel or the remote entity.

49. The method of claim 48, wherein the remotely controlling further includes:
remotely controlling at least three of power applied to downhole sensors, actuation of motor-driven downhole components, winch actuation, adjusting logging speed, adjusting data sampling rate, and selecting data presentation formats.

50. The method of claim 48, wherein the directing activities further includes:
selecting at least one wireline logging tool; and
verifying use of the at least one wireline logging tool.

51. The method of claim 48, wherein the directing activities further includes:
providing a graphical user interface to a remote customer included in the remote entity that duplicates a portion of an interface presented to a remote engineer included in the remote entity.

52. The method of claim 48, further including:
concurrently validating data generated by the well-site logging system by at least two of a well-site engineer or operator, a remote engineer included in the remote entity, and another witness.

53. The method of claim 48, wherein the directing activities further includes:
directing offloading a logging tool;
directing assembling the logging tool; and
directing deployment of the logging tool into a well.

54. The method of claim 48, wherein the providing further includes:
providing the electronic audio, visual, and data communication via satellite.

55. The method of claim 48, wherein the providing further includes:
providing the electronic audio, visual, and data communication via a wireless connection.

56. A computer-readable medium having instructions stored thereon which, when executed by a computer, cause the computer to perform a method comprising:
remotely controlling a well-site logging system;
directing activities of well-site logging personnel; and
providing electronic audio, visual, and data communication to enable communication between a remote entity and the well-site logging personnel using a global computer network, and to enable remote control of the well-site logging system by either the well-site logging personnel or the remote entity.

57. The computer-readable medium of claim 56, wherein the instructions, when executed by the computer, cause the computer to perform a method comprising:
acquiring logging data via the well-site logging system; and
adjusting conduct of a drilling operation activity based on the logging data in substantially real time.

58. The computer-readable medium of claim 56, wherein the instructions, when executed by the computer, cause the computer to perform a method comprising:
providing an alarm to a well-site engineer or operator included in the well-site logging personnel and a remote engineer included in the remote entity.

59. The computer-readable medium of claim 56, wherein the instructions, when executed by the computer, cause the computer to perform a method comprising:
presenting video representations of data to a remote engineer included in the remote entity from at least two well logging jobs, wherein some of the data is acquired by the well-site logging system.

60. An apparatus, including:
a remote control equipment to remotely control a well-site logging system;
a well-site computer workstation to couple to the remote control equipment, the well-site computer workstation to display operations at the well-site; and
electronic audio, visual, and data communication equipment to couple to the well-site computer workstation and to a global computer network to enable communication between a remote engineer and a remote customer, and to enable control of the remote control equipment by either the remote engineer or the remote customer.

61. The apparatus of claim 60, wherein the remote control equipment includes:
a camera to record cable drum movement associated with operation of a remote winch control.

62. The apparatus of claim 60, further including:
a display to display visual representations of remote control operations associated with the remote control equipment, and of data acquired by the well-site logging system.
